(19) United States
(12) Patent Application Publication
(10) Pub. No.: US 2003/0093311 A1
(43) Pub. Date: May 15, 2003

(54) Targeted advertising

(76) Inventor: Kenneth Knowlson, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/011,953

(22) Filed: Nov. 5, 2001

(51) Int. Cl. G06F 17/60

(52) U.S. Cl. 705/10

(57) ABSTRACT

Suggesting and targeting advertising based at least in part on relationships between individuals in a community and monitored activity of the individuals. Advertising may be targeted according to inferred relationships between individuals. For example, if a household is determined to have four members comprising a man and woman much older than two children, it may be inferred that the man and woman are parents, and the parents may be targeted to receive advertising for birthday presents for the children. Targeting may be refined based at least in part on monitored responses to previous advertising. A common access point, such as a home computer or portable device may be used as one means of monitoring individual activity.

### FIELD OF THE INVENTION

The invention generally relates to advertising, and more particularly to targeting advertising based at least in part on inferred relationships between individuals in a community, and refining targeting based at least in part on monitored responses to advertising.

### BACKGROUND

There have been many approaches applied to targeted advertising. In the Internet context, advertising is generally blind, or targeting is generally performed with respect to preference profiles that exist for users, e.g., individuals or groups, using an Internet site. These profiles are generally set with default advertising values, e.g., send all types of advertising, or determined with respect to a user's feedback or interaction with the site. A common limitation of such advertising models, however, is that little valuable information is collected from users. For example, default values tells an advertiser nothing about a user, as the defaults are not set by the user. Direct feedback also has limitations, as it is frequently lacking, incomplete, or intentionally misleading or wrong. For example, users commonly lie about their age, location, etc.

Improved techniques are needed for targeting advertising to users.

### BRIEF DESCRIPTION OF THE DRAWINGS

The features and advantages of the present invention will become apparent from the following detailed description of the present invention in which:

FIG. 1 illustrates an exemplary system in which aspects of the invention may be practiced.

FIG. 2 is a flowchart in accordance with one embodiment of the invention illustrating use of a wireless device 100 (FIG. 1) to control a home electronic device.

FIG. 3 is a flowchart in accordance with one embodiment of the invention illustrating monitoring use of a wireless device and presenting advertising.

FIG. 4 illustrates a suitable computing environment in which certain aspects of the invention may be implemented.

### DETAILED DESCRIPTION

In order to improve advertising targeting to users, it is assumed that a common access point is used by members of a community, e.g., a family, classroom students, building tenants, faculty, etc., to access services. The access point may be a computer terminal, portable computer, wireless device, e.g., a tablet, Personal Digital Assistant (PDA), etc., or other machine generally accessible to the community. For exemplary purposes only, it is assumed that the community is a family, and the access point is a home wireless device communicatively coupled with advertisers by way of public and/or private networks, such as wireless networks, the Internet, or other networks. It will be appreciated that the invention may be applied to other communities or contexts, and that the access point need not be wireless.

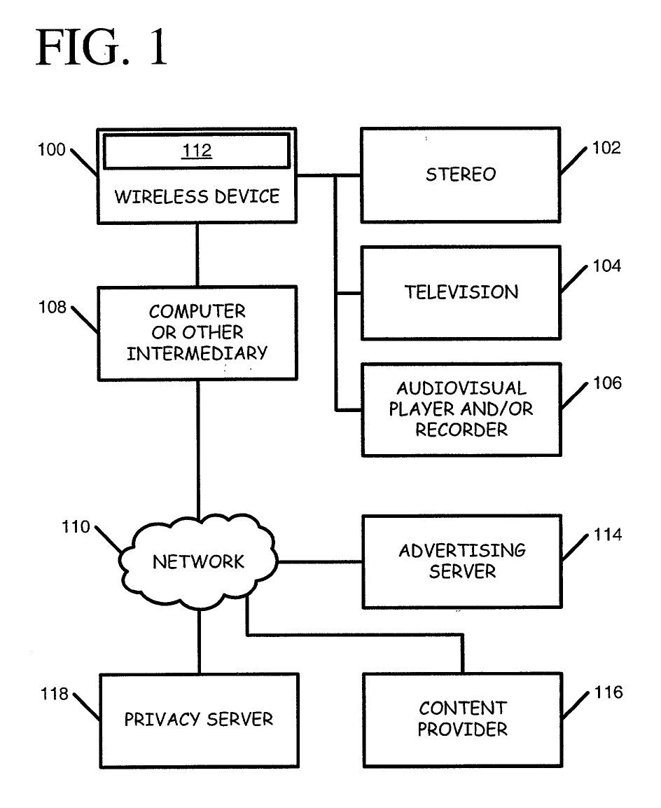

FIG. 1 illustrates an exemplary system in which aspects of the invention may be practiced. Illustrated is a wireless device 100 communicatively coupled to a home entertainment device, such as a stereo 102, television 104, audiovisual recorder and/or playback device 106, or other device. For example, the wireless device may be a “universal” remote control for various entertainment or other equipment within the house. In the illustrated embodiment, the wireless device is also communicatively coupled to a network 110 by way of a computer 108 or other intermediary device.

Thus, the wireless device may a low-powered or low-speed device providing a user interface, while significant processing tasks, storage requirements, etc. are relegated to the more powerful computer. It will be appreciated that the wireless device may be sufficiently configured, e.g., with processing power, storage resources, etc. so as to not need an intermediary, and in this embodiment, may be directly connected to the network. It will be further appreciated that the wireless device may be connected to the home entertainment devices 102, 104, 106, over a communication path including the network 110.

In one embodiment, the wireless device is communicatively coupled to one or more advertising servers 114 and/or content providers 116 by way of the network 110 or other communication pathway. In one embodiment, the wireless device includes a display 112, such as a multiple-line text display or graphics display. The display may be used to show advertisements or other data to a user of the wireless device, and in one embodiment, advertisements or other content may be flagged for later processing, such as to allow later retrieval of a full advertisement with the computer 108. For example, the wireless device may be used to select a certain song on the stereo 102; a special offer may be displayed one the wireless device related to the selected song, and the a user of the wireless device may flag the offer for later review.

In one embodiment, users of the wireless device log in or otherwise identify themselves to the device, such as by entering their name, selecting a user identifier code, activating a biometric recognizer, e.g., a fingerprint recognizer, etc., signing their name on a signature reader, etc. Once logged in, as will be discussed with reference to subsequent figures, activities of the user of the wireless device are monitored so as to profile interests of the user for providing advertisements to the user. In addition, relationships between the user and other members of the community, e.g., the family, may be used to target advertisements presented to a user. For example, when a child user has an impending birthday, a parent user may receive advertisements for the child's birthday.

Regarding providing advertisements to a user of the wireless device, it will be appreciated that various push and/or pull models may be employed by the advertising servers 114 and/or content providers 116. Advertising preferences, e.g., user profiles, may be stored on the wireless device 100, on the computer 108, and/or on the advertising servers or content providers (depending on the desired advertising arrangement). Advertising preferences may be used to direct pushed or pulled advertising. In one embodiment, to provide privacy, a privacy server 118 is used to hide individual members of communities receiving advertising. The privacy server may be a separate machine or grouping of machines, or it may operate as an application program or hardware construct of the wireless device, local computer, or other machine.

Thus, for example, as interests of users of the wireless device are collected, this information may be aggregated at the privacy server. The privacy server can then interact with advertising servers and/or content providers based at least in part on the collected user interests to acquire advertising that is provided to a user of the wireless device. However, the advertising servers and/or content providers are not informed which community members receive what advertising.

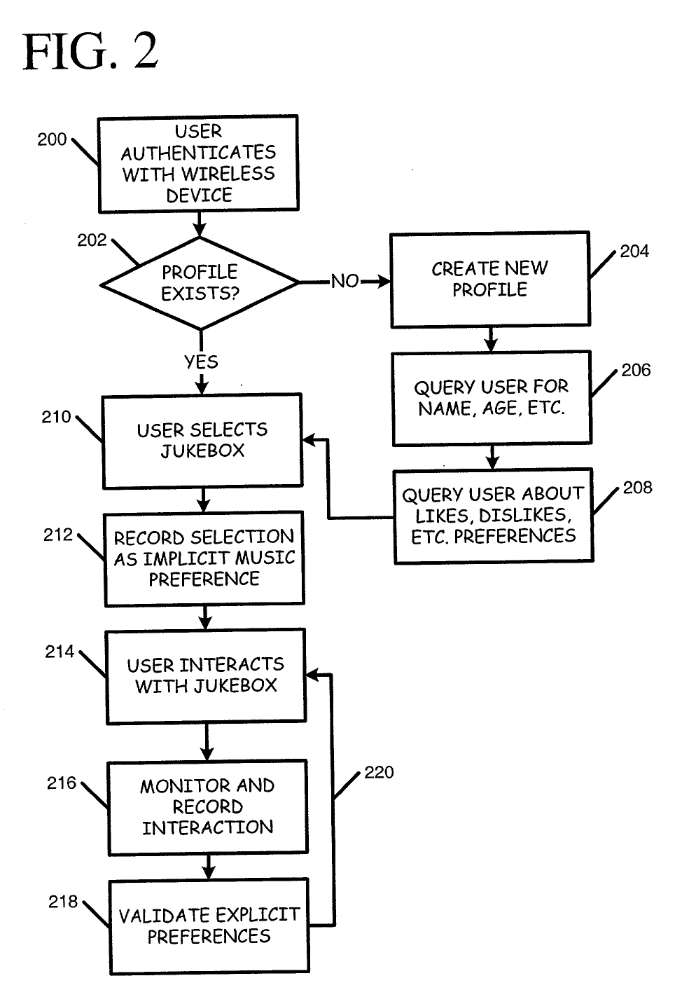

FIG. 2 is a flowchart in accordance with one embodiment of the invention illustrating use of a wireless device 100 (FIG. 1) to control a home electronic device, such as a home music jukebox.

A user of the wireless device authenticates 200 to the device, e.g., logs in, signs on, etc. A test 202 may be performed to determine whether the user already has an existing profile tracking explicit and/or implicit preferences of the user. In one embodiment, a single profile is maintained including user identification data and user preferences for various categories of interests, e.g., movies, music, books, etc. that the user likes or dislikes. In another embodiment, multiple profiles are maintained.

If the test 202 indicates there is no existing profile for the user, then a new-user profile is created 204. Profile creation may include querying 206 the user for identification information about the user, such as name, age, apparel sizes, hair or eye color, nickname, address (if the wireless device is being used by users having different addresses), etc. Profile creation may include asking 208 the user for explicit preferences, such as entertainment liked or disliked by the user, reading preferences, vacation preferences, etc. It will be appreciated that a wide variety of preferences may be requested from a user.

In addition explicitly asking 208 for user preferences, implicit data may also be obtained about a user. For example, assuming there are multiple devices available for control, the user selects 210 a jukebox as a particular electronic device to control with the wireless device. Selection of the jukebox device may be recorded 212 for statistical purposes for determining musical interests of the current user. When the user interacts 214 with the jukebox, for example, the user selects songs, navigates through different songs, reads descriptions of songs, related song data, etc. (assuming the wireless device is configured to display song titles), the interaction can be monitored and recorded 216. The monitored interaction may be used to statistically derive implicit interests of the current user in addition to the ones explicitly provided.

The following table illustrates exemplary explicit and implicit user preferences that may be stored in a user profile according to one embodiment of the invention:

| Characteristic | Value |
|---|---|
| Explicit: Name | Mom |
| Explicit: Birthday | January 1, 1950 |
| Explicit: Shirt Size | Small |
| Explicit: Pant Size | 8 |
| Explicit: Height | 5′ 6″ |
| Explicit: Weight | 135 lbs |
| Implicit: Spouse | Dad |
| Implicit: Children | Child 1, Child 2 |
| Implicit: Music Likes | Classical, Jazz |
| Implicit: Music Dislikes | Heavy Metal; Opera |
| Implicit: Movie Likes | Romance, Science Fiction |
| Implicit: Movie Dislikes | Westerns |
| . | . |
| . | . |
| . | . |

Note the Implicit: Spouse and Implicit: Children entries. When the users Dad, Child1, and Child2 initially authenticate with using the wireless device, and enter some basic identification information, such as age, it can be inferred from this information how the users relate, and this inferred relationship can be used to target advertising.

In one embodiment, derived implicit interests may be compared against explicit interests divulged by the user to validate 218 explicit data provided by a user. For example, the user may be monitored as frequently listening to a certain genre of music, and frequently skipping over another type of music. This implies an interest in the genre of music listened to, and a dislike of the music skipped over. However, the user may have explicitly stated an interest in the music frequently skipped. If a pattern of skipping music is detected, then an explicit interest in that music may be called into question, and advertising no longer provided, or a query sent to the user to confirm continued interest. Monitoring and recording repeats 220 as users interact with the jukebox, allowing building, refining, and cross-referencing user preference profiles.

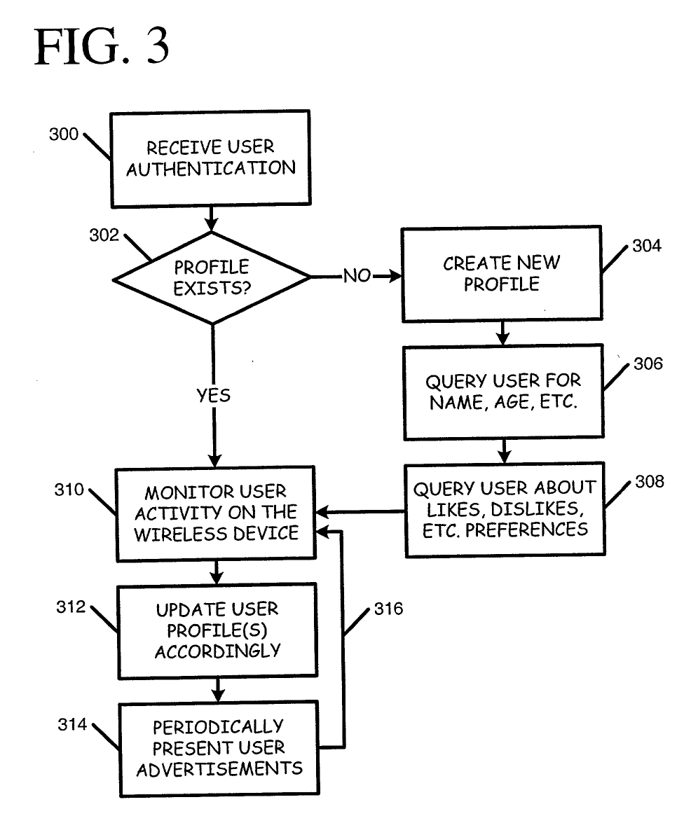

FIG. 3 is a flowchart in accordance with one embodiment of the invention illustrating monitoring use of a wireless device 100 and presenting advertising. It will be appreciated that, depending on the advertising arrangement, a variety of different machines may be monitoring activity, including the local computer 108, advertising servers 110, content providers 112, or privacy server 114 illustrated in FIG. 1.

A user is identified 300 based on an authentication with the wireless device. A test 302 is performed to determine whether there is an existing profile for the user. If not, a new (empty or default-filled) profile is created 304, and the user is queried 306 for identification data and queried 308 for preference data as discussed above for FIG. 2. If a profile already exists, or when creating an initial profile completes, user activity with the wireless device is monitored 310 as discussed above, and the user's profile is updated 312 accordingly. Periodically, while monitoring the user, advertisements are presented 314 to the user.

Depending on the advertising model, as discussed above, advertisements may be pushed to the wireless device from (FIG. 1) advertisers 110, content providers 112, or a privacy server 114, or pulled to the wireless device or local computer 108 (if used). Presented 314 advertisements may be targeted to the user based on current activity, preference profile content, relationships between users of the wireless device, or other criteria. For example, if the user is listening to a certain song and there is going to be a concert including that song, the user might be presented with an advertisement for purchasing tickets for the concert.

In one embodiment, if certain relationships have been inferred between users of the wireless device, for example, that the user is a parent of a child user of the wireless device (e.g., based on ages provided when creating a profile), advertising may be presented based on the inferred relationship. For example, if the parent selects a music playing device, the parent may be shown an advertisement on behalf of a child having an upcoming birthday. Thus, rather than blindly sending advertisements as is typically done today, instead, advertisements are targeted not only according to explicit and implicit interests of the user, but also according to implicit or explicit relationships between related users, e.g., parent-child, brother-sister, aunt-nephew, etc.

For example, if the child is perceived as liking video games and a certain genre of music, but monitoring the parent indicates the parent dislikes that music genre, then birthday advertisements may be targeted to the parent for games of interest to the child, but not for the music because the parent is unlikely to be receptive to the music advertisements. It will be appreciated that weights may be ascribed to preferences, so that an apparent extreme desire by one user for a product may outweigh a less-strong dislike by another user of the product. It will be further appreciated that apparent social significance of a product may affect sending an advertisement. For example, if a current fad among children is to have a product, then the product may be advertised to the parent, possibly indicating it is a fad, notwithstanding an apparent dislike by the parent for the product.

In one embodiment, past purchases by the user may target an advertisement. That is, if the user is known to have previously purchased a certain type of product, and a different user's profile indicates an interest in that product, the user may be presented with an advertisement for that product on behalf of the other user. For example, if a husband has previously purchased jewelry, and a wife has expressed interest in jewelry, then the husband may receive jewelry advertising. It will be appreciated that many different advertising scenarios may be presented based on explicit and inferred preferences and the relationships between different users of the wireless device. In one embodiment, to protect privacy, past purchase data and/or purchase inferences are encrypted or otherwise encoded to prevent undesired access to this data. In another embodiment, purchase history is maintained on a privacy server, e.g., FIG. 1 item 118, which may also utilize encryption.

If an advertisement interests a user of the wireless device, the user may select the advertisement for processing, e.g., viewing, hearing, etc., on the wireless device, or the advertisement may be marked for later review on the computer 108 (FIG. 1) or other machine. This later option is particularly useful when the abilities of the wireless device are limited with respect to the local computer; software and/or hardware of the local computer is provided with a reference to the selected advertisement. And, as with other monitored 310 activity, selecting the advertisement implies the user is interested in the advertised product, and this implication can be used to update 312 the user's profile(s) accordingly. Monitoring the user interaction and updating the user's profile(s) repeats 316.

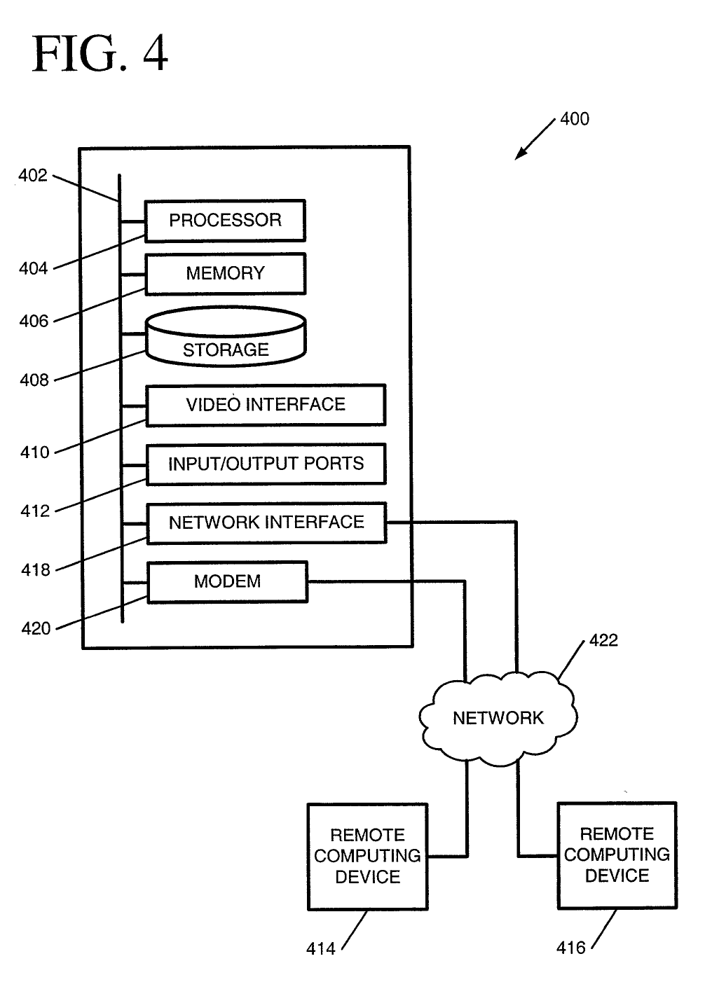

FIG. 4 and the following discussion are intended to provide a brief, general description of a suitable computing environment in which certain aspects of the illustrated invention may be implemented. An exemplary system for embodying, for example, the wireless device 100 or local computer 108 of FIG. 1, includes a machine 400 having system bus 402. As used herein, the term “machine” includes a single machine, such as a computer or other machine, or a system of machines or other communicatively coupled devices operating together.

Typically, attached to the bus are processors 404, a memory 406 (e.g., RAM, ROM), storage devices 408, a video interface 410, and input/output interface ports 412. The machine 400 may be controlled, at least in part, by input from conventional input devices, such as keyboards, mice, joysticks, as well as directives received from another machine, a user's interaction with a virtual reality (VR) environment, biometric feedback, e.g., data incident to monitoring a person, plant, animal, organism, etc., or other input.

The system may also include embedded controllers, such as Generic or Programmable Logic Devices or Arrays, Application Specific Integrated Circuits, single-chip computers, smart cards, or the like, and the system is expected to operate in a networked environment using physical and/or logical connections to one or more remote machines 414, 416 through a network interface 418, modem 420, or other data path. Machines may be interconnected by way of a wired or wireless network 422, such as the network 110 of FIG. 1, an intranet, the Internet, local area networks, wide area networks, cellular, cable, laser, satellite, microwave, “Bluetooth” type networks, optical, infrared, or other short range or long range wired or wireless carrier.

The invention may be described by reference to or in conjunction with program modules, including functions, procedures, data structures, application programs, etc. for performing tasks, or defining abstract data types or low-level hardware contexts. Program modules may be stored in memory 406 and/or storage devices 408 and associated storage media, e.g., hard-drives, floppy-disks, optical storage, magnetic cassettes, tapes, flash memory cards, memory sticks, digital video disks, biological storage. Program modules may be delivered over transmission environments, including network 422, in the form of packets, serial data, parallel data, propagated signals, etc. Program modules may be used in a compressed or encrypted format, and may be used in a distributed environment and stored in local and/or remote memory, for access by single and multi-processor machines, portable computers, handheld devices, e.g., Personal Digital Assistants (PDAs), cellular telephones, etc.

Thus, for example, with respect to the illustrated embodiments, assuming machine 400 is the computer 108 of FIG. 1, then remote machines 414, 416 may respectively be advertising servers 110 and content servers 112 from which advertising may be received and presented on the wireless device. It will be appreciated that remote machines 414, 416 may be configured like machine 400, and therefore include many or all of the elements discussed for machine.

Having described and illustrated the principles of the invention with reference to illustrated embodiments, it will be recognized that the illustrated embodiments can be modified in arrangement and detail without departing from such principles. And, though the foregoing discussion has focused on particular embodiments, other configurations are contemplated. In particular, even though expressions such as “in one embodiment,” “in another embodiment,” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description is intended to be illustrative only, and should not be taken as limiting the scope of the invention. What is claimed as the invention, therefore, is all such modifications as may come within the scope and spirit of the following claims and equivalents thereto.

What is claimed is:

1. A method for targeting advertising, comprising:
providing an identity of a user to a common access point, the user belonging to a community of users using the common access point, the user having an associated first profile comprising interests of the user and a relationship between the user and an other member of the community of users; and
receiving an advertisement at the common access point.

2. The method of claim 1, further comprising:
inferring relationships between the user and other members of the community based at least in part on registration data provided by the user.

3. The method of claim 1, wherein the relationships between the user and the community of users is explicitly determined based on registration data provided by members of the community of users.

4. The method of claim 1, wherein the advertisement is based at least in part on the relationship between the user and the other member of the community of users.

5. The method of claim 4, wherein the relationship between the user and the other member of the community of users is inferred.

6. The method of claim 1, further comprising:
the user using the common access point to access a type of entertainment;
wherein the user using the common access point is monitored to facilitate updating the profile for the user based at least in part on the monitoring.

7. The method of claim 6, wherein monitoring the user occurs on a server separate from and communicatively coupled with the common access point.

8. The method of claim 6, wherein the advertisement is related to the type of entertainment accessed.

9. The method of claim 6, wherein the advertisement is received based at least in part on a first interest in the profile for the user, and a second interest in the profile for the other member.

10. The method of claim 1, further comprising:
monitoring a user using the common access point to control an entertainment device; and
inferring interests of the user based at least in part on the monitoring.

11. The method of claim 1, further comprising:
monitoring a user using the common access point to control an entertainment device; and
confirming explicit interests provided by the user during a registration of the user based at least in part on the monitoring.

12. The method of claim 1, further comprising:
inspecting a second profile associated with the other member;
wherein receiving the advertisement is based at least in part on inspecting the second profile.

13. The method of claim 12, further comprising:
identifying a celebratory event for the other member.

14. A system for targeting advertising, comprising:
a common access point configured to receive an identity of a user belonging to a community of users using the common access point; and
a memory communicatively coupled with the common access point for storing a profile associated with the user, the profile comprising interests of the user and at least one relationship between the user and an other member of the community;
wherein the common access point is further configured to receive an advertisement for the user based at least in part on the relationship in the profile between the user and the other member of the community.

15. The system of claim 14, wherein the common access point is further configured to perform:
authenticating the user;
providing the identity of the authenticated user and the relationship in the profile to an advertising server; and
receiving the advertisement from the advertising server.

16. The system of claim 14, wherein the common access point and the advertising server comprise a machine.

17. The system of claim 16, wherein the machine comprises a distributed network of communicatively coupled machines.

18. The system of claim 14, wherein the common access point is further configured to perform:
providing the identity of the authenticated user and the relationship in the profile to a privacy server;
wherein the privacy server anonymously provides the identity of the user to an advertising server, receives the advertisement from the advertising server, and provides the advertisement to the common access point.

19. An article comprising a machine-accessible media having associated data, wherein the data, when accessed, results in a machine performing:
providing an identity of a user to a common access point, the user belonging to a community of users using the common access point, the user having an associated first profile comprising interests of the user and a relationship between the user and an other member of the community of users; and
receiving an advertisement at the common access point.

20. The article of claim 19 wherein the machine-accessible media further includes data, when accessed by the machine, results in the machine performing:
inferring relationships between the user and other members of the community based at least in part on registration data provided by the user.

21. The article of claim 19, wherein the relationships between the user and the community of users is explicitly determined based on registration data provided by members of the community of users.

22. The article of claim 19, wherein the advertisement is based at least in part on the relationship between the user and the other member of the community of users.

23. The article of claim 22, wherein the relationship between the user and the other member of the community of users is inferred.

24. The article of claim 19 wherein the machine-accessible media further includes data, when accessed by the machine, results in the machine performing:
the user using the common access point to access a type of entertainment;
wherein the user using the common access point is monitored to facilitate updating the profile for the user based at least in part on the monitoring.

25. The article of claim 24, wherein monitoring the user occurs on a server separate from and communicatively coupled with the common access point.

26. The article of claim 24, wherein the advertisement is related to the type of entertainment accessed.

27. The article of claim 24, wherein the advertisement is received based at least in part on a first interest in the profile for the user, and a second interest in the profile for the other member.

28. The article of claim 19 wherein the machine-accessible media further includes data, when accessed by the machine, results in the machine performing:
monitoring a user using the common access point to control an entertainment device; and
inferring interests of the user based at least in part on the monitoring.

29. The article of claim 19 wherein the machine-accessible media further includes data, when accessed by the machine, results in the machine performing:
monitoring a user using the common access point to control an entertainment device; and
confirming explicit interests provided by the user during a registration of the user based at least in part on the monitoring.

30. The article of claim 19 wherein the machine-accessible media further includes data, when accessed by the machine, results in the machine performing:
inspecting a second profile associated with the other member;
wherein receiving the advertisement is based at least in part on inspecting the second profile.

31. The article of claim 30 wherein the machine-accessible media further includes data, when accessed by the machine, results in the machine performing:
identifying a celebratory event for the other member.

32. Machine-accessible information embodied in a propagated signal for targeting advertising which, when accessed, results in a machine performing:
providing an identity of a user to a common access point, the user belonging to a community of users using the common access point, the user having an associated first profile comprising interests of the user and a relationship between the user and an other member of the community of users; and
receiving an advertisement at the common access point.

33. The propagated signal of claim 32 wherein the signal further includes information, when accessed by the machine, results in the machine performing:
inferring relationships between the user and other members of the community based at least in part on registration data provided by the user.

34. The propagated signal of claim 32 wherein the signal further includes information, when accessed by the machine, results in the machine performing:
monitoring a user using the common access point to control an entertainment device; and
inferring interests of the user based at least in part on the monitoring.

35. The propagated signal of claim 32 wherein the signal further includes information, when accessed by the machine, results in the machine performing:
monitoring a user using the common access point to control an entertainment device; and
confirming explicit interests provided by the user during a registration of the user based at least in part on the monitoring.

36. The propagated signal of claim 32 wherein the signal further includes information, when accessed by the machine, results in the machine performing:
inspecting a second profile associated with the other member, wherein receiving the advertisement is based at least in part on inspecting the second profile.

37. The propagated signal of claim 36 wherein the signal further includes information, when accessed by the machine, results in the machine performing:
identifying a celebratory event for the other member.
